(19) United States
(12) Patent Application Publication
(10) Pub. No.: US 2007/0280217 A1
(43) Pub. Date: Dec. 6, 2007

(54) Inter-nodal robust mode for real-time media streams in a network

(75) Inventors: Thomas Francis Flanagan, Springfield, VA (US); William Emil Witowsky, Potomac, MD (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/445,103

(22) Filed: Jun. 1, 2006

(51) Int. Cl. H04L 12/66

(52) U.S. Cl. 370/356

(57) ABSTRACT

Providing a method and software solution to add robustness to real-time media streams such as voice, video and audio streams on a network. When the network channel carrying the media stream experiences an adverse condition that affects the transmissions, such as high packet loss or corruption of packets, a robust mode is activated at an intermediate node of the end-to-end transmission for the media stream to the destination link. The robust mode of the present invention may be activated on specific network links that are experiencing the network problems and not necessarily on the end-to-end communication path. Under certain conditions, an intermediate network node may terminate robust mode in packets received from an upstream link when the network channel in question no longer experiences the adverse network condition.

### CROSS-REFERENCE TO RELATED APPLICATIONS

None

### FIELD OF THE INVENTION

The present invention relates to improving transmission efficiency of a real-time media stream over a network.

### BACKGROUND OF THE INVENTION

In typical telecommunications systems, voice calls and data are transmitted by carriers from one network to another network. Networks for transmitting voice calls include packet-switched networks transmitting calls using voice over Internet Protocols (VoIP), circuit-switched networks like the public switched telephone network (PSTN), asynchronous transfer mode (ATM) networks, etc. Recently, voice over packet (VOP) networks are becoming more widely deployed. Many incumbent local exchange and long-distance service providers use VoIP technology in the backhaul of their networks without the end user being aware that VoIP is involved.

In a packet network, a message to be sent is divided into separate blocks of data packets that are the same or variable lengths. The packets are transmitted over a packet network and can pass through multiple servers or routers. The packets are then reassembled at a receiver before the payload, or data within the packets, is extracted and reassembled for use by the receiver's computer. To ensure the proper transmission and re-assembly of the data at the receiving end, the packets contain a header which is appended to each packet and contains control data and sequence verification data so that each packet is counted and re-assembled in a proper order. A variety of protocols are used for the transmission of packets through a network. Over the Internet and many local packet-switched networks the Transport Control Protocol/Internet Protocol (TCP/UDP/IP) suite of protocols and RTP/RTP-XR are used to manage transmission of packets.

A wired network can include a WLAN (Wireless Local Area Network) leg. WLANs utilize RF (Radio Frequency) signals or light signals to connect mobile endpoints to each other or to a centralized gateway and transmit data over a wireless medium between the physical endpoints or between a mobile endpoint and an endpoint on a network that is connected to the WLAN. In 1997 the IEEE published standards for one type of WLAN under the title of 802.11 (also known as “Wi-Fi”). Currently, most of these networks are used for data access from laptop computers and personal digital assistants (PDAs). The basic hardware setup of an IEEE 802.11 network is the Basic Service Set (BSS), which is merely a number of endpoint stations that communicate with one another. In a BSS, IEEE 802.11 enables wireless mobile stations (STAs) to communicate through a wireless network interface directly with each other or with other stations through an access point. An access point (AP) is a centralized gateway providing message and power management and access to an external LAN (Local Area Network) and/or the Internet. An ESS is larger than a BSS and can be a combination of BSSs or a BSS and other associated network nodes, components, and LAN lines. An Independent Basic Service Set (IBSS), also called “ad-hoc” is merely a single BSS where two mobile STAs can communication with one another without the need for a master STA or AP.

An example of a multimedia network capable of transmitting a VOIP call or real-time video is illustrated in FIG. 1. The diagram illustrates a network 10 that could include managed LANs and WLANs accessing the Internet or other Broadband Network 12 such as an packet network with IP protocols, Asynchronous Transfer Mode (ATM), frame relay, or Ethernet. Broadband network 12 includes many comments that are connected with devices generally known as “nodes.” Nodes include switches, routers, access points, servers, and end-points such as user's computers and telephones. The network 10 includes a media gateway 20 connected between broadband network 12 and IP phone 18. On the other end, wireless access point (AP) 22 is connected between broadband network 12 and wireless IP phone 24. A voice over IP call may be placed between IP phone 18 and Wireless IP phone 24 using appropriate software and hardware components. In this call, voice signals and associated control packet data are sent in a real-time media stream between IP phone 18 and phone 24.

Factors that affect voice quality in a real-time media network 10 are fairly well understood. The level of control over these factors will vary from network to network. This is highlighted by the differences between a well-managed small network enterprise verses an unmanaged network such as the Internet. Network operational issues affect network performance and will create conditions that affect voice and multi-media quality. These issues include outages/failures of network switches, routers, and bridges; outages/failure of VoIP elements such as call servers and gateways; and traffic management during peak periods and virus/denial of service attacks.

In an ideal situation, all packets transmitted through a wired or wireless packet network will arrive in the proper order at the receiver. However, due to high rates of packet loss and delay, especially with Internet transmissions, this is not always the case. Packets may be lost or delayed either one at a time or in a burst of a group of packets. Voice over Packet (VOP) and Voice over Internet Protocol (VOIP) are sensitive to delay jitter to an extent qualitatively more important than for text data files for example. Delay jitter produces interruptions, clicks, pops, hisses and blurring of the sound and/or images as perceived by the user, unless the delay jitter problem can be ameliorated or obviated. Packets that are not literally lost, but are substantially delayed when received, may have to be discarded at the destination nonetheless because they have lost their usefulness at the receiving end. Thus, packets that are discarded, as well as those that are literally lost are all called “lost packets.”

In TCP there is a protocol for responding to packet loss in an IP network by the receiver sending an acknowledgement packet to the transmitter. If the acknowledgement is not received at the transmitter, then the packets are re-transmitted. This procedure, however, can add significant delay to the signals. Since multi-media must be transmitted and played out in real-time, the possibility of re-transmissions of data streams are usually not a realistic option.

For these reasons different packet correction schemes have been implemented in networks including jitter buffers, error concealment methods, and packet loss concealment. Some of these techniques are incorporated into codecs adopted by the ITU. One type of correction method that is used to combat the problems associated with packet loss is called forward error correction (FEC). The forward error correction algorithms at the transmitter receive packetized voice or other media as input. New packets designated as FEC packets are created and transmitted out of the receiver or original packets are encoded with FEC. FEC packets are associated with multi-media packets when the media packets are used to generate the FEC packets. The payload of the FEC packets contains information describing which media packets correspond to the FEC packets. A simpler attempt to improve the reliability of packet links deploys redundancy wherein the packet payloads are duplicated and sent numerous times under the assumption that enough of the duplicates will arrive at the decoding device for the stream to be accurately recreated.

The path that a real-time media stream (e.g., voice, video, streaming audio) takes as it crosses a packet network often consists of numerous nodes prior to reaching an endpoint such as IP phones 18 and 26. The interconnecting network components and lines (e.g., LANs, wireless LANs, broadband links, etc.) are susceptible to packet loss that adversely affects the quality of the reproduced media. There are existing end-to-end solutions to this problems where the endpoints monitor the transmission stream for packet loss and, when necessary or when pre-configured to do so, transmit duplicate or redundant packets or use FEC schemes. In FIG. 2, the network of FIG. 1 is illustrated with the nodes 14 and 16 shown as router 26 and router 28, respectively. Represented by dashed line 30, an end-to-end solution described above would cover the entire network from MG 20 at one end to the AP 22 and IP phone 24 over the wireless link. This broad scope solution necessitates that the packets that are being transmitted solely for the purpose of increasing the robustness of the real-time transmission traverse the entire path even if the source of the network problem may only be occurring on a single link in the network.

The result of the end-to-end solution 30 is that the remaining links of the network that are functioning without problems carry the redundant information unnecessarily. This consumes bandwidth unnecessarily, which could further degrade the performance of the real-time media stream.

### SUMMARY

The present invention, as described in the preferred and alternative embodiments, provides a method and software solution to add robustness to media streams on a network, such as a packet network, that experience network problems such as high packet loss, delay, jitter, and corruption of packets. Real-time media such as voice, video, and audio streams require high quality of service when transmitting over a packet network because of the common problems of delay and loss of packets. The robust mode of the present invention may be activated on specific network links that are experiencing the network problems and not necessarily on the end-to-end communication path. This can save bandwidth on links that are not experiencing packet loss or other problems since the links do not have to carry the extra payload in each packet that is required when implementing a redundancy or error-correction method.

Each node, such as a router, switch, access point, in the network path monitors the communication channel for packet loss. When loss is detected, packets destined for that channel processed in the robust mode. Robust mode includes a packet duplication method or forward error correction coding. Duplication of packets means replacing the IP header of the packet with a new header indicating that redundant information is contained within the payload, not re-creating the header and payload of the packet. Duplicate packets are then transmitted to the destination link in order to improve the probability that sufficient packets are arriving at the next node. The higher quality of transmission results in a higher quality replication of the original voice, video, or audio encoding.

### BRIEF DESCRIPTION OF THE DRAWINGS

For a better understanding of the nature of the present invention, its features and advantages, the subsequent detailed description is presented in connection with accompanying drawings in which:

FIG. 1 is a diagram of a network capable of transmitting a real-time media stream;

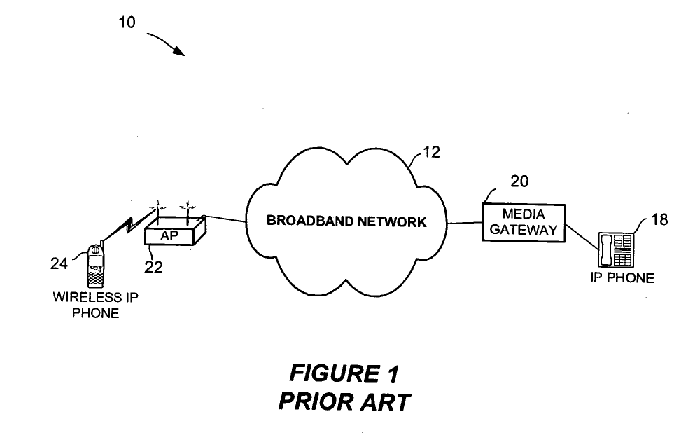

FIG. 2 is the network diagram of FIG. 1 showing routers as nodes in the network;

FIG. 3 is diagram of a network on which the method of the preferred embodiment may be implemented showing the preferred embodiment activated between two intermediate nodes;

FIG. 4 is a flowchart showing a method of the preferred embodiment;

FIG. 5 is a diagram of a network showing the preferred embodiment activated between an endpoint an intermediate node;

FIG. 6 is a diagram of a typical packet format;

FIG. 7 is a flowchart showing a method of an alternative embodiment;

FIG. 8 is a flowchart showing a method of an additional alternative embodiment;

FIG. 9 is an additional network diagram capable of implementation of the present invention.

### DETAILED DESCRIPTION OF THE INVENTION

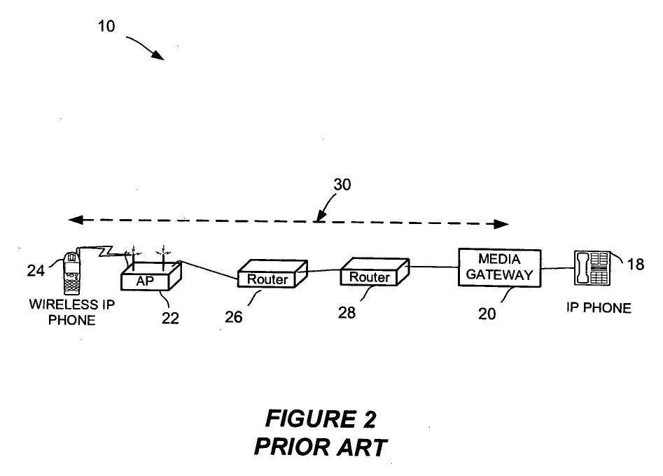

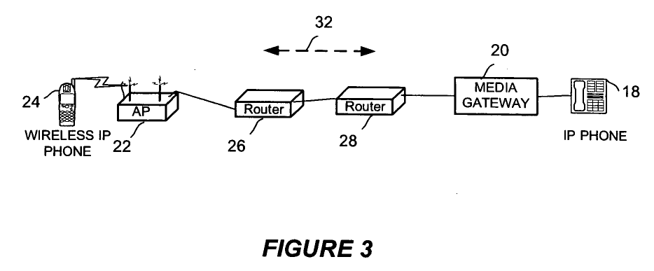

FIG. 3 illustrates a network diagram of FIG. 2 that can implement the preferred and alternative embodiments. Network 32 comprises router 26 that contains components as is known in the art of network interfaces, printed circuit boards, and processors used for reception and transmission of network media streams. For purposes of explanation, routers 26 and 28 are exemplary network nodes and assumed to have equivalent hardware components and software capabilities to implement the present invention. Further, each node on the network is assumed to contain a processor such as an integrated circuit (IC), central processing unit (CPU), reduced-instruction set computer (RISC), or an equivalent processor capable of programming and controlling the transmission of a network media stream to implement the preferred and alternative embodiments. In FIG. 3, exemplary nodes include IP phones 18 or 24 (which are also endpoints), media gateway 20, router 28, router 26, and wireless access point (AP) 22.

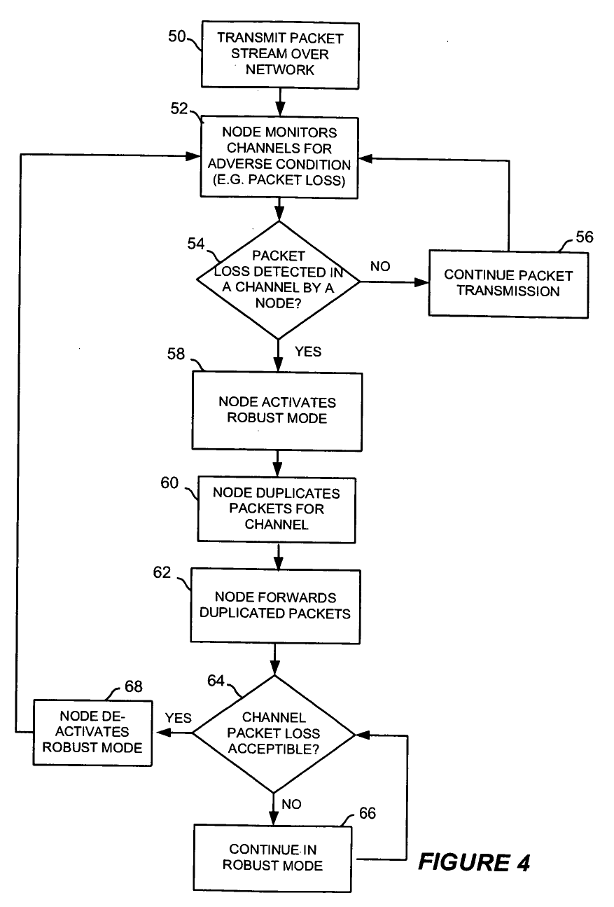

Steps for the method of the preferred embodiment for network 32 are included in the flowchart diagram of FIG. 4. The preferred method is intended for use during transmission of a real-time media stream transmitted over a network beginning in step 50. This transmission in occurs between two endpoints such as between IP phone 18 and IP phone 24 over the nodes in the network. One or more nodes in the network monitors communication channels for adverse network transmission problems 52 such as packet loss, delay, corruption, etc. (for purposes of describing the preferred embodiment it is assumed that packet loss is the adverse network event detected in a communication channel). Each node monitors the media stream in the channel it is receiving from its upstream network link.

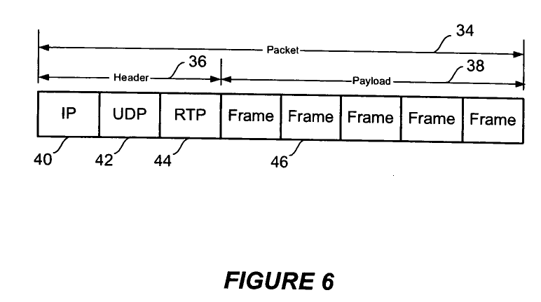

If packet loss is not detected 54 above a tolerable level for the network, then the node continues packet transmission in its normal operational mode 56 and continues to monitor channels for problems 52. If packet loss is detected 54, then the node detecting the loss activates the preferred method of operation to reverse the adverse network effects on the media stream. This is termed the “robust mode” in flowchart step 58. In a network running RTP/RTP-XR media streams of voice, video, audio, and/or data payloads, the robust mode 58 may be activated on one or more specific links in the network that are experiencing the packet loss, delay, etc., and not necessarily on the entire end-to-end communication path. FIG. 3 illustrates such an implementation only on the link 32 between routers 26 and 28 when that link is experiencing packet loss and the remaining network links are not experiencing loss. If packet loss is occurring on the wireless link between AP 22 and phone 24, then FIG. 6 illustrates the robust mode operating on the link 48 between those two nodes. In a packet network, when packet loss is detected 54 and the node enters the robust transmission mode 58, the RTP (Real-Time Protocol) and its associated control protocol (CP) RTCP or RTP-XR (RPT extended Reporting) packets destined for that particular communication channel are duplicated 60 by the transmitting node for that channel. Duplication 60 of packets is performed to improve the probability that sufficient packets are arriving at a downstream node that will produce a high-quality replication of the original voice, video, audio, or data that was originally packetized at the upstream endpoint 20. The duplication 60 operations may be performed by any methods known in the art, such as according to Request for Comments (RFC) 2198 “RTP Payload for Redundant Audio Data” or equivalent packet duplication method.

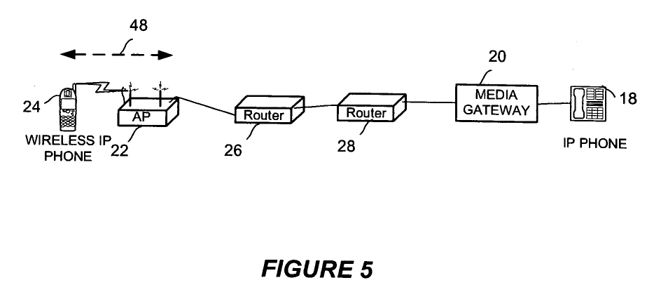

One method is for the node in robust mode 58 to generate appropriate replacement RTP/RTP-XR packet headers for the original packet it has already received. A typical packet format is illustrated in FIG. 5. Packet 34 comprises a header 36 and a payload 38. An IP header 36 includes an IP address frame 40, a user datagram protocol (UDP) frame 42, and a Real Time Protocol (RTP) frame 44. UDP serves as an application interface to the IP and since it has no reliability, flow control, or error-recovery capabilities, also serves as a multiplexer/demultiplexer for the receiving and sending of IP traffic. Payload 38 includes multiple frames 46 of voice, video, or audio data. The payload message format 46 for RTP supports various types of codecs, such as ITU G.729, G.711 and other protocols known in the art. If a different type of network, such as frame relay, implements the preferred embodiment, then the appropriate frame headers or signal identifiers are changed without changing the data portion.

The embodiment preferably only changes the header portion 36 of a packet. Codecs used to encode, decode, or transcode the media payload 38 are not required at the nodes implementing the preferred embodiment. The codecs used for transmission protocols between endpoints would remain as expected in the transmission. This further serves a purpose of not interfering with the specialized protocols used in a VOIP call or other media transmissions. Such interference with the codecs of payload by a node could potentially create delay or loss of payload at the receiving endpoint 26. However, if transcoding is desired at an intermediate node in the network channel either by an application or by a network operator, codecs could be present at the desired intermediate node without compromising the node from taking advantage of the features of the present invention.

The preferred method duplicates packets even though the duplicating node may not be the originating or terminating endpoint for the media stream. Once an intermediate node duplicates packets 60 on the channel experiencing loss, the node forwards the duplicated packet in step 62 to the next downstream node or endpoint. The node will continue to monitor the channel experiencing loss to determine 64 if, after implementing the robust operations 58, the losses in the channel decrease to an acceptable rate. If the losses are not acceptable then the node continues in robust mode in step 66 and continues to monitor the channel 64. If during monitoring 64 the channel losses are lowered to an acceptable rate, the node de-activates robust mode 68 and returns to transmission of packets normally while continually monitoring the channel for network problems 52.

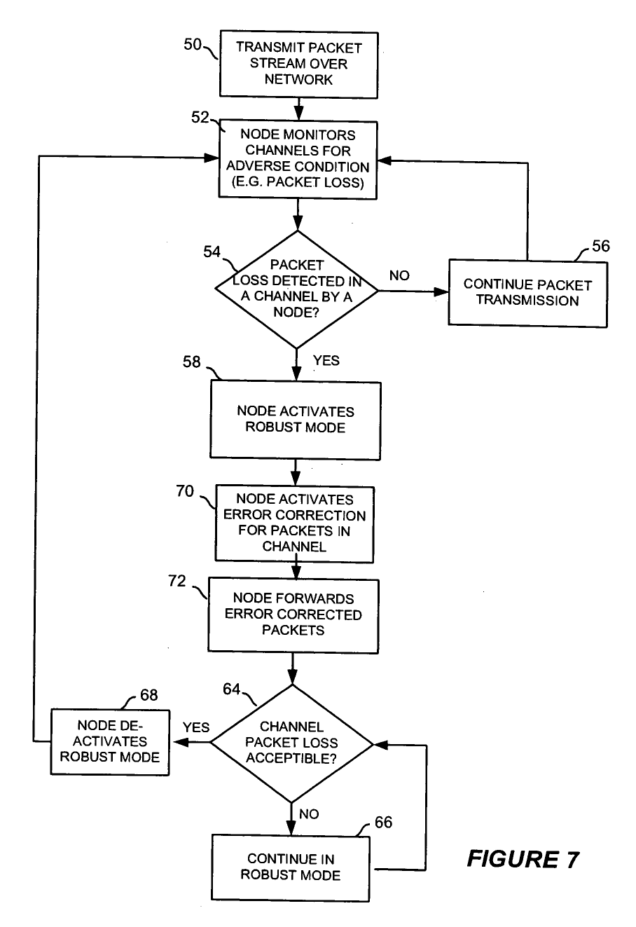

Although the preferred method implements a packet duplication operation 60 at an intermediate node, alternative embodiments may implement other error-correction schemes on one or more intermediate links in the media transmission. An alternative embodiment of a method for inter-nodal robust mode is illustrated in the flowchart of FIG. 7. The alternative method is also intended for inter-nodal real-time media stream on a network. Step 50 in FIG. 7 begins with transmission of a packet stream 50 with one or more nodes monitoring channels 52 for network problems. Again, a problem with packet loss on the network is illustrated and described but this could be any type of adverse network event replay problems including delayed packets, lost packets, packet corruption, etc. After packet loss is detected 54 and the activation of robust mode 58 at an intermediate node on the network 32, the node activates a forward error correction (FEC) scheme for packets in the channel experiencing loss. The node then forwards the FEC-encoded packets downstream 72 to the next node. When packet loss in the channel is deemed acceptable 64, the FEC-encoding is stopped at the node by de-activating the robust mode 68.

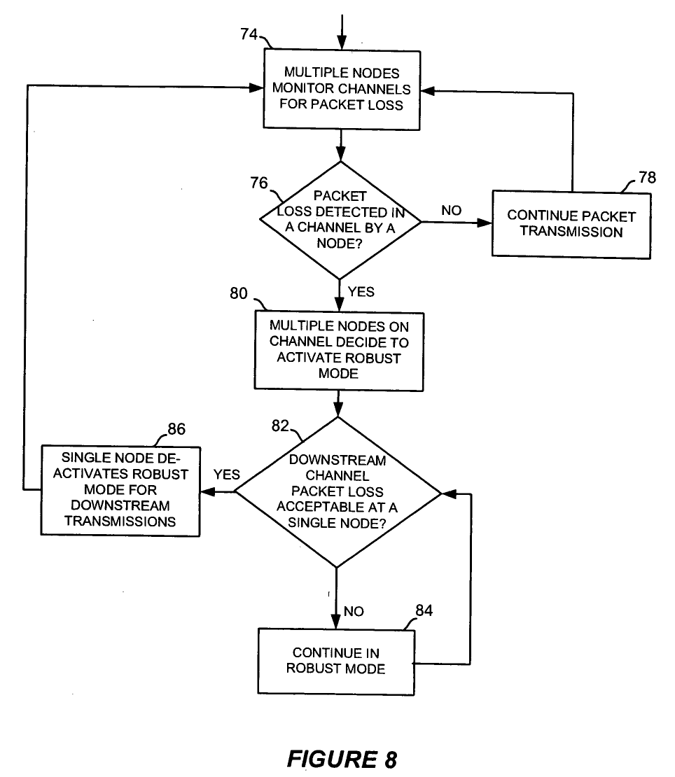

FIG. 8 contains a flowchart illustrating steps of an additional alternative embodiment that can be implemented at a node that may not be the originating or terminating endpoint during a real-time media stream transmission. The process begins with multiple nodes monitoring a transmission stream channel 74 for a problem with the network, for example packet loss above an acceptable rate. As is understood from the preferred embodiment, this method is applicable for other network transmission problems as is known in the art such as lost packets, delayed packets, and corruption. If the packet loss parameters are not detected 76, then the node continues with packet transmission 78 in normal operation and continues monitoring channels for packet loss 74. If the packet loss parameters are detected as unacceptable 76 by multiple nodes, then those nodes on the channel links experiencing problems decide to active the robust mode 80 as described in the preferred embodiment. Thus, in this scenario there is a node, such as router 28, that has entered robust mode and a downstream node, such as router 26 that has entered robust mode of their downstream links. When the channel in the destination link over which a node in robust mode is forwarding packet in question is determined by that node to have an acceptable packet loss 82, then that node may de-activate robust mode transmission 86 only if that node participated in the decision to enter robust mode that in a channel that it was monitoring directly.

In FIG. 3, this would be the case where router 26 participated in the decision to enter robust mode for the destination link between itself and AP 22. If steps 82 and 86 are satisfied, then router 26 could terminate the redundant packets 60 or FEC encoding 70 of packets it is receiving from router 28. If the destination link from router 26 does not have an acceptable level of packet loss 82, then the router 26 continues in robust mode 84 while monitoring the destination link. The alternative method terminating robust mode by an intermediate node that participated in the decision to enter the robust mode is extremely advantageous. This method removes the possibility that an intermediate node will terminate the transmission of duplicate packets when an upstream link requires them and the upstream node is not able to monitor and activate the a robust mode by itself.

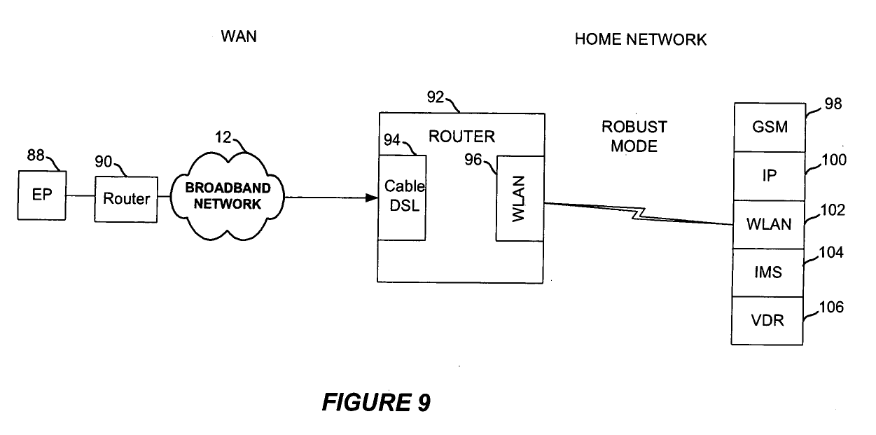

FIG. 9 illustrates a more detailed view of a view of an exemplary network that could implement the present invention. Endpoint 88 is connected to broadband network 12 through router 90. Router 92 is part of a home network and connects to broadband network 12 through a cable or DSL network interface card 94. Router 92 transmits on a wireless LAN connection 96 to any one or all of additional networks, applications, or devices that comprise the home network. These include applications and devices for Global System for Mobile Communications (GSM) 98, Internet Protocol 100, WLAN 102, Internet Mail Service (IMS) 104, and a voice/data router (VDR) 106. If the connection between router 90 and router 92 experiences unacceptable packet loss etc., router 92 enters the robust mode 58 for transmissions from router 92 and the devices and applications of the home network described above.

The present invention has numerous advantages that are extremely important to improving the transmission of real-time media streams over a network. These include bandwidth savings in the network by eliminating redundancy on network links that do not require a redundancy scheme in order to maintain quality of service. Additionally, the processing overhead required to implement the invention is minimal. Processing is performed in a distributed fashion, in one or more processors at each node on the network links. The nodes capable of robust mode may also communicate with one another using control signaling from a central location or with inter-nodal signaling or with indicators within the packet headers. This has an advantage of notifying all nodes in the destination links that they can expect to process packets transmitted in the robust mode and to insure proper reporting to a network operator of what links activate robust mode and how often. Once the need to activate a robust mode is detected by a network node, the node will generate the appropriate replacement headers for the original packet that is has already received. There is no requirement for re-transmission or duplication of packets starting from an originating endpoint nor is acknowledgement of receipt of duplicate packets required.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A method for real-time media stream transmission in a network, comprising:
transmitting an end-to-end real-time media stream through a first intermediate node in a network channel of the network;
detecting an adverse network condition in the channel downstream of the intermediate node that affects the transmission of the media stream;
applying a robust mode scheme, at the first intermediate node, to the media stream on a destination link of the first intermediate node.

2. The method of claim 1, wherein the applying the robust mode scheme comprises duplicating packets of the media stream and transmitting the duplicated packets to the destination link.

3. The method of claim 2, wherein the duplicating packets comprises replacing the headers in the packets of the media stream and transmitting the packets with the replaced headers to the destination link.

4. The method of claim 1, wherein the applying the robust mode scheme comprises adding a forward error correction to packets of the media stream and transmitting the error-corrected packets to the destination link.

5. The method of claim 1, wherein the applying occurs at a node that is not an originating or terminating endpoint of the media stream transmission.

6. The method of claim 1, further comprising:
providing a second intermediate node, downstream of the intermediate node, that participates in the applying the robust mode scheme; and
terminating the robust mode scheme in the destination link of the second node when the adverse network condition is not present in the destination link of the second node.

7. The method of claim 2, wherein the detecting the adverse network condition comprises detecting one of a packet loss, jitter, or delay condition that is not acceptable according to a quality of service for delivery of the real-time media stream to an endpoint.

8. The method of claim 1, wherein the applying further comprises applying the robust mode scheme between the intermediate node and a destination endpoint in the real-time media stream.

9. A system for media stream transmission in a network, comprising:
a first endpoint and a second endpoint connected across a channel of the network, wherein the first endpoint transmits the media stream through a first intermediate node to the second endpoint;
wherein the first intermediate node comprises a processor that can perform re-transmission of the media stream,
wherein the processor is notified of an adverse condition that affects the transmission of the media stream in a destination link of the first node that includes a downstream part of the channel from the first node, and
the processor applies a robust mode scheme to the media stream and re-transmits the media stream on the channel downstream of the intermediate node.

10. The system of claim 9, further comprising:
a second intermediate node, connected to the network downstream of the first intermediate node, that handles the media transmission to a destination link channel of the second node,
wherein the second intermediate node comprises a processor that participates in the decision to apply the robust mode scheme at the first intermediate node, and
the second node processor terminates the robust mode scheme in the destination link channel of the second node when the adverse network condition is not present in the destination link of the second node.

11. The system of claim 9, wherein the processor applies the robust mode scheme by duplicating packets of the media stream and transmitting the duplicated packets to the destination link.

12. The system of claim 11, wherein the processor duplicates packets by replacing the headers in the packets of the media stream and transmitting the packets with the replaced headers to the destination link.

13. The system of claim 9, wherein the processor applies the robust mode scheme by adding a forward error correction to packets of the media stream and transmitting the error-corrected packets to the destination link.

14. The system of claim 9, wherein the first intermediate node is not an originating or terminating endpoint of the media stream transmission.

15. The system of claim 10, wherein the processor detects the adverse network condition that is one of a packet loss, jitter, or delay condition that is not acceptable according to a quality of service for delivery of the real-time media stream to the second endpoint.
